(19) United States
(12) Patent Application Publication
(10) Pub. No.: US 2005/0011617 A1
(43) Pub. Date: Jan. 20, 2005

(54) Window blind selective closure device

(76) Inventor: Paul Maire, Snowmass, CO (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/844,643

(22) Filed: May 13, 2004

Related U.S. Application Data
(60) Provisional application No. 60/471,303, filed on May 16, 2003.

(51) Int. Cl. E06B 9/38

(52) U.S. Cl. 160/178.1 R

(57) ABSTRACT

This application relates generally to a selective closure device for venetian blinds having a corded or webbed ladder. The devices shown herein are used with a ladder cord, but could also be used with a webbed form of venetian blind. In general these devices relate to shortening the ladder cord of a venetian blind at a selected location to close the venetian blind below that location.

This application claims priority to U.S. Provisional Application Ser. No. 60/471,303 filed May 16, 2003.

### BACKGROUND OF THE INVENTION

This application relates generally to a selective closure device for venetian blinds having a corded or webbed ladder. The devices shown herein are used with a ladder cord, but could also be used with a webbed form of venetian blind. In general these devices relate to shortening the ladder cord of a venetian blind at a selected location to close the venetian blind below that location.

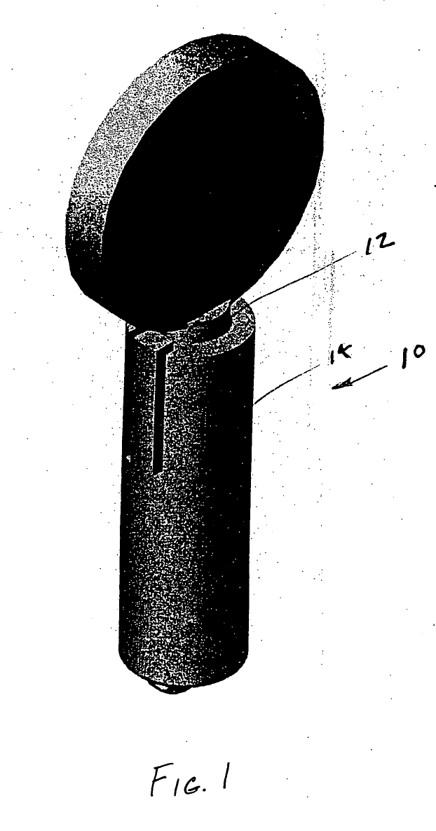

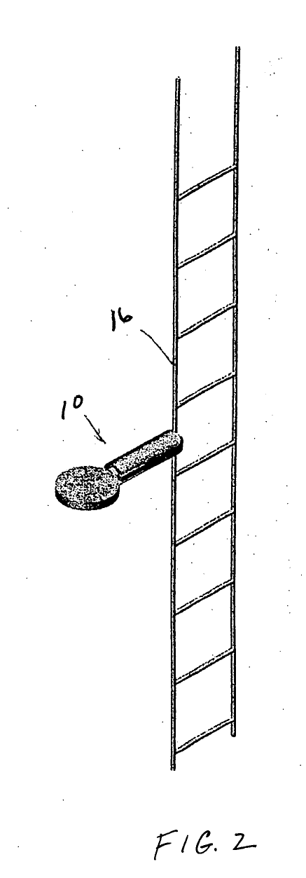

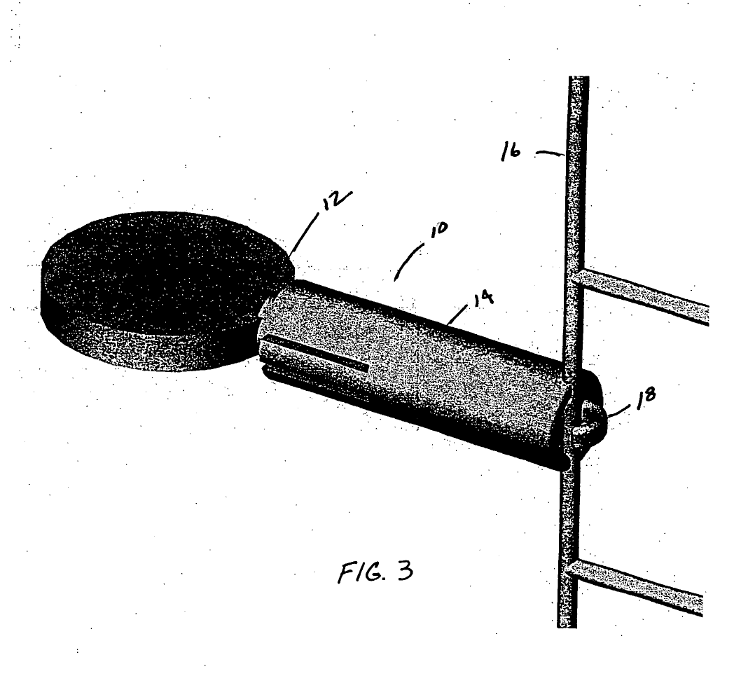

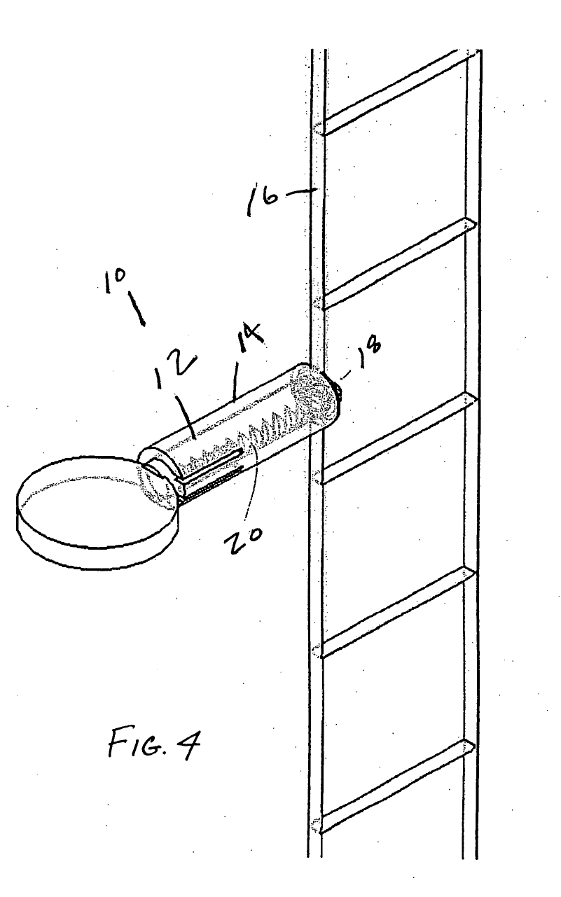

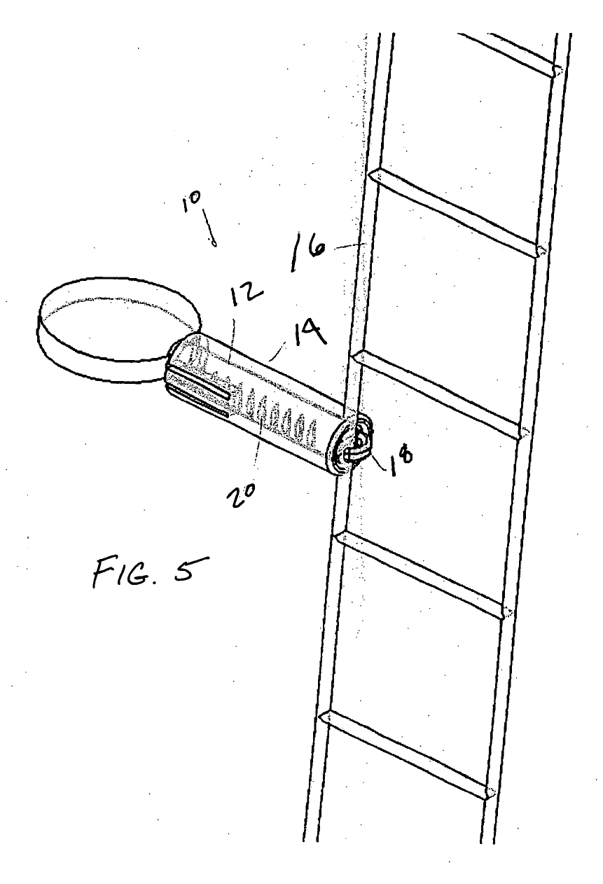

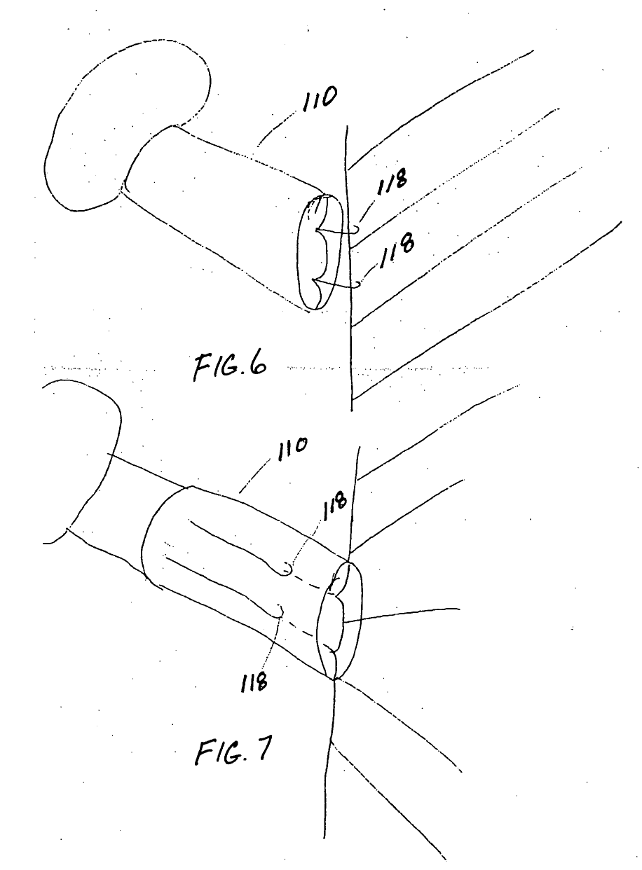

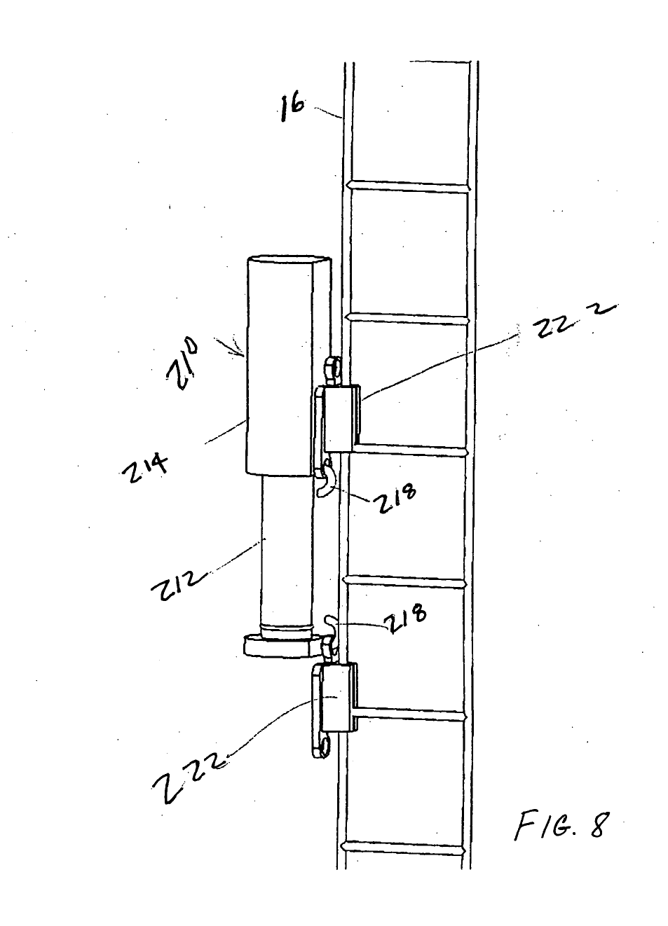

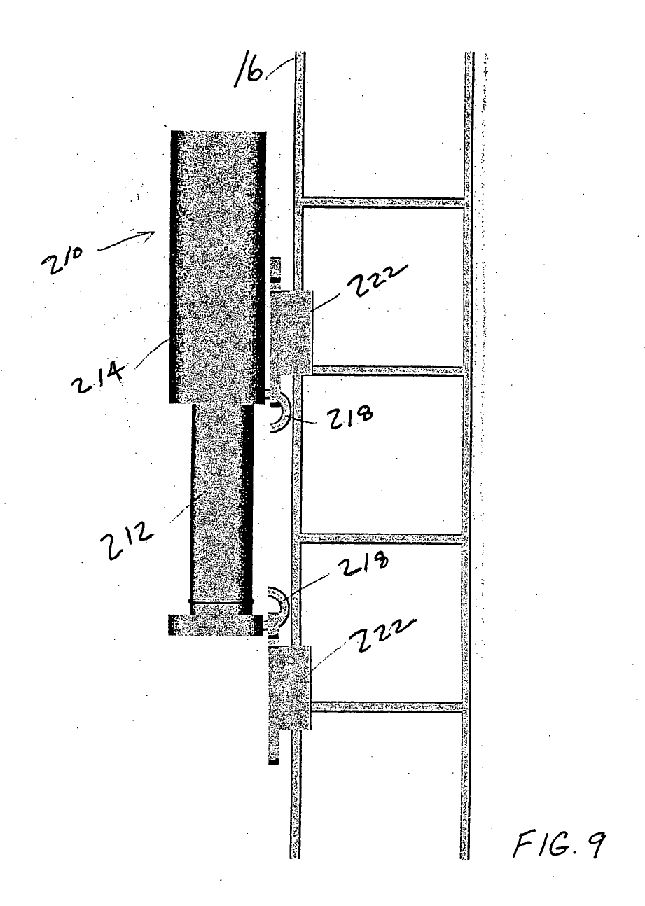

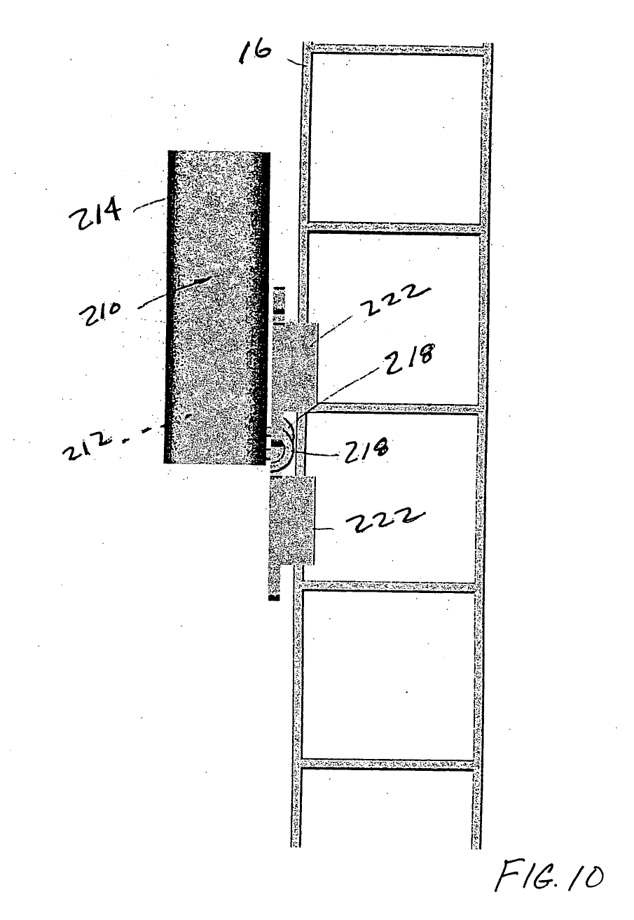

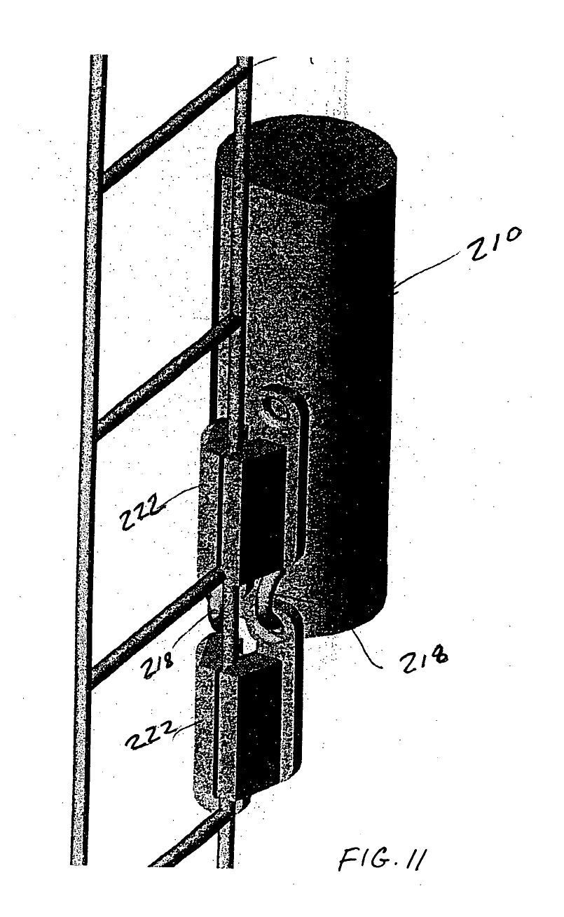

FIGS. 1 through 5 relate to a first embodiment of a device 10. In this embodiment an inner shaft 12 is slidably disposed in an outer shaft 14. FIG. 2 shows the device connected to a ladder cord 16 of a venetian blind. FIG. 3 shows a hook 18 connected to inner shaft 12 providing the connection. FIG. 4 is a view through outer shaft 14 of inner shaft 12 including a ratchet mechanism 20 which will hold the position of inner shaft 12 relative to outer shaft 14 at various locations. If inner shaft 12 is drawn in a direction away from ladder cord 16, a portion of ladder cord 16 will be drawn into outer shaft 14 effectively shortening the length of ladder cord 16. FIG. 5 is an alternate view of the device shown in FIG. 4.

FIGS. 6 and 7 show an alternate embodiment 110 of a device 10 of FIGS. 1 through 5. In this alternate embodiment, two spaced hooks 118 are provided.

FIGS. 8 through 13 show an alternate device 210. In this case an inner shaft 212 is slidably and ratchetaby disposed within an outer shaft 214. Inner shaft 212 and outer shaft 214 each include hooks 218. One way to connect device 210 to ladder cord 16 is by way of hooks 218 which can be connected to ladder cord gripping means 222. Alternatively, device 210 could include ladder cord gripping means. FIG. 9 is an alternate view of device 210 of FIG. 8. FIG. 10 is a view of device 210 where inner shaft 212 has been slide into outer shaft 214 bringing hooks 218 closer together. As means 222 are vertically fixed in position along cord 16, bringing hooks 218 together effectively shortens cord 16. This position can be releasably held by an internal ratchet mechanism similar to that shown with respect to device 10. FIG. 11 shows an alternate view of device 210 where means 222 include a slot for placing them on to cord 16. Sides of device 222 opposite the slot can be biased towards each other to grip cord 16. FIGS. 12 and 13 are alternate views of device 210.

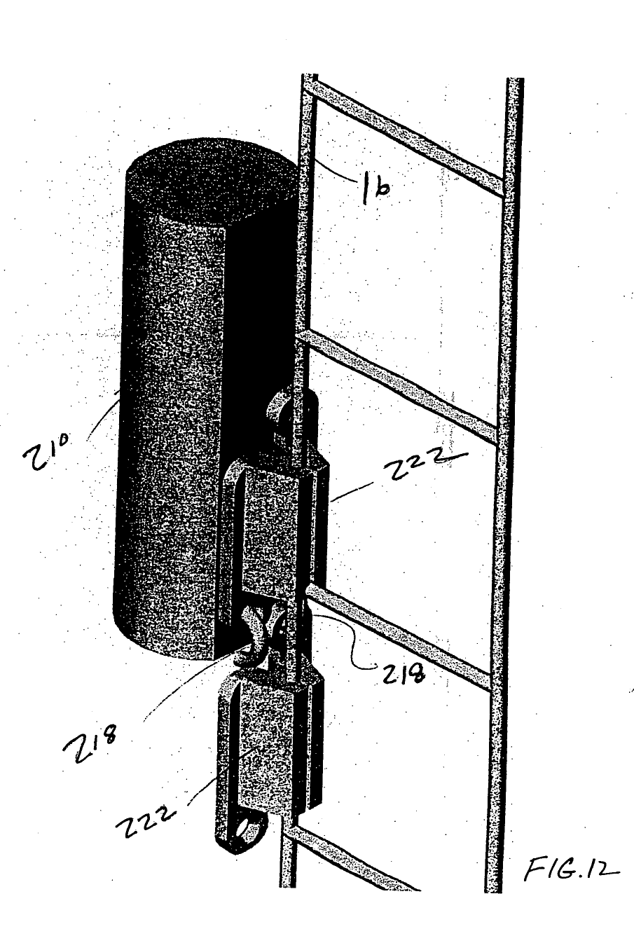

FIGS. 14 through 15 show an alternate embodiment 310. Device 310 is a scissor like device having a spring 324 disposed at its pivot point. Spring 324 biases hooks 318 towards each other. Device 310 can be connected to means 222 to drawn them together effectively shortening cord 16. FIG. 15 is an alternate view of device 310 of FIG. 14.

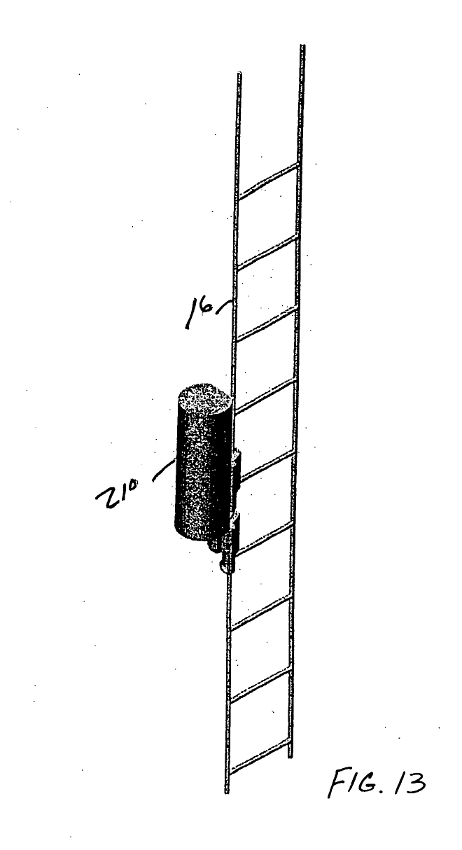

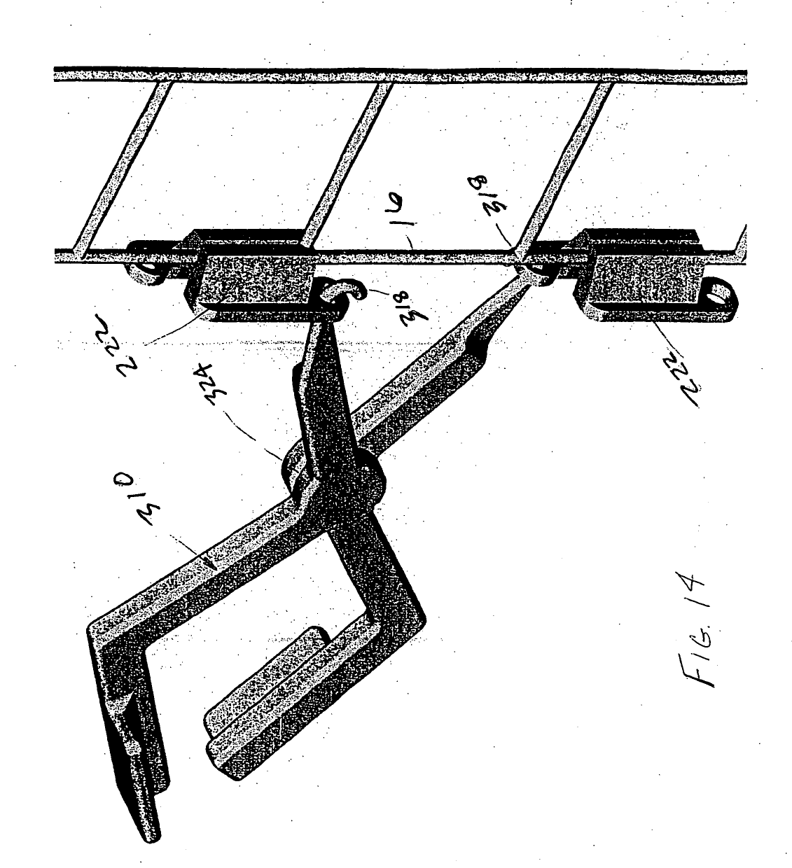

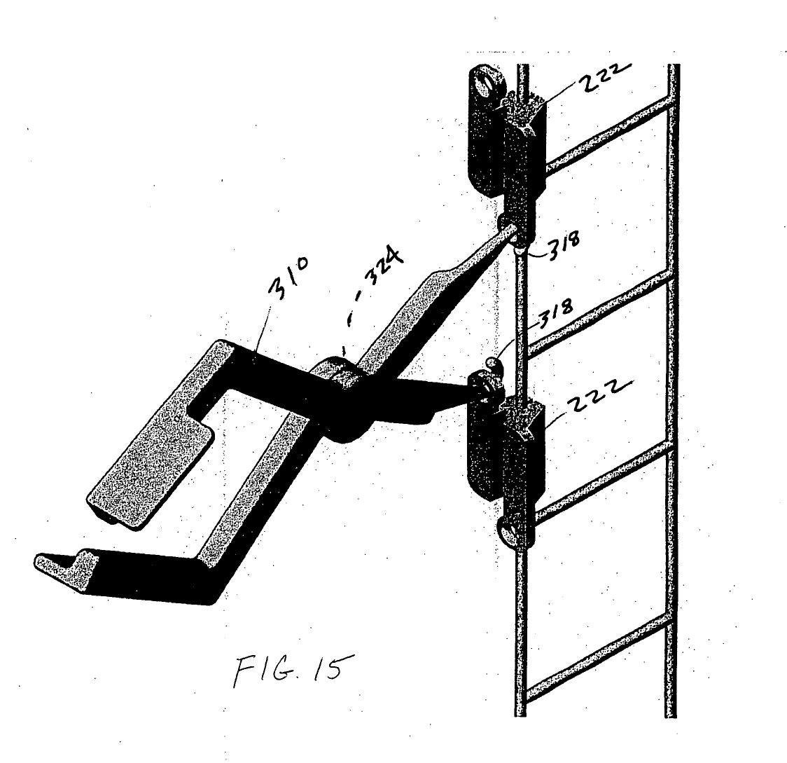

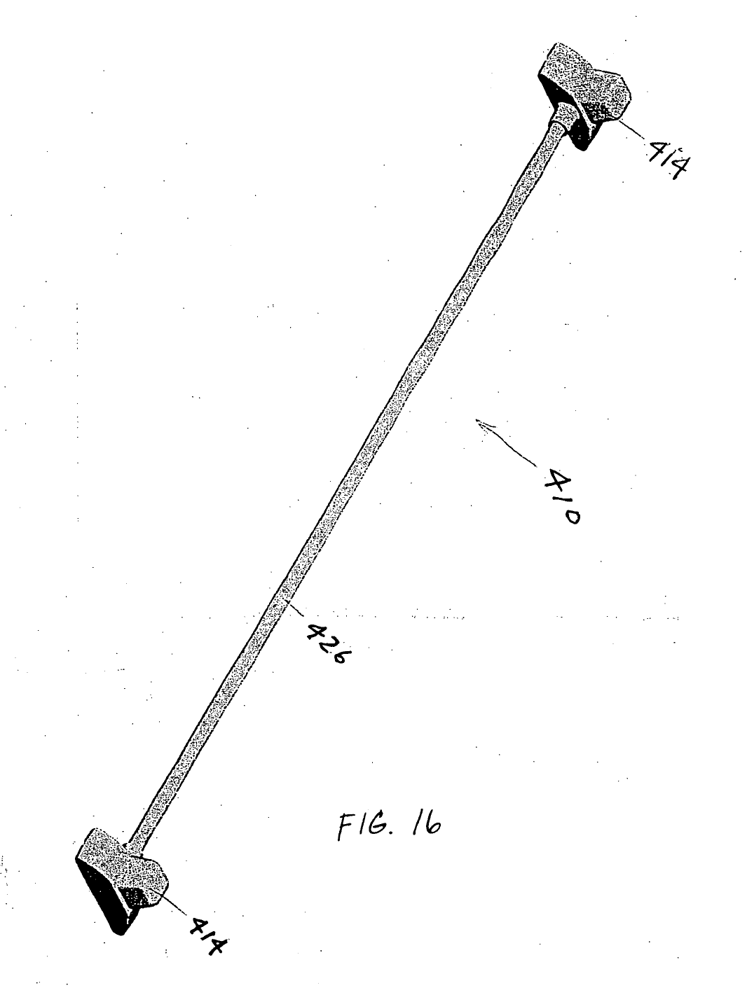

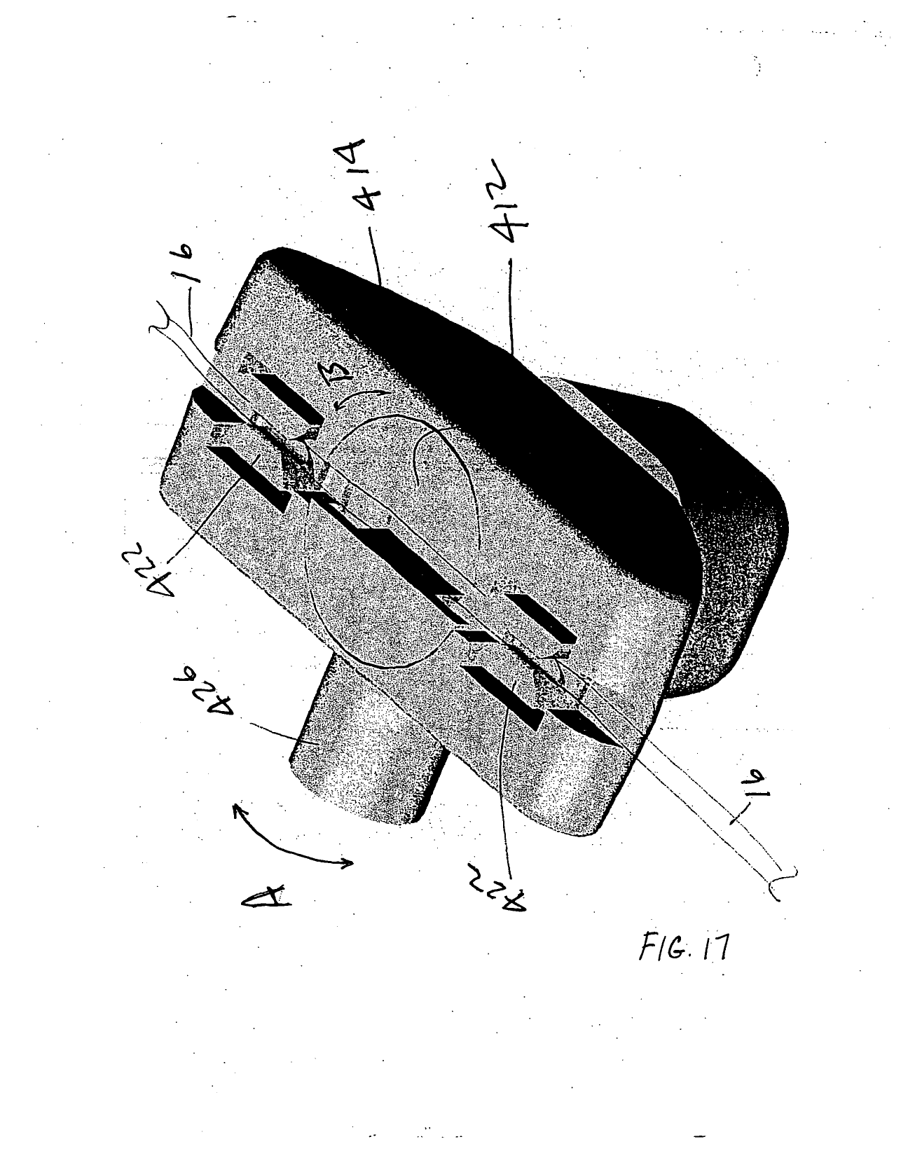

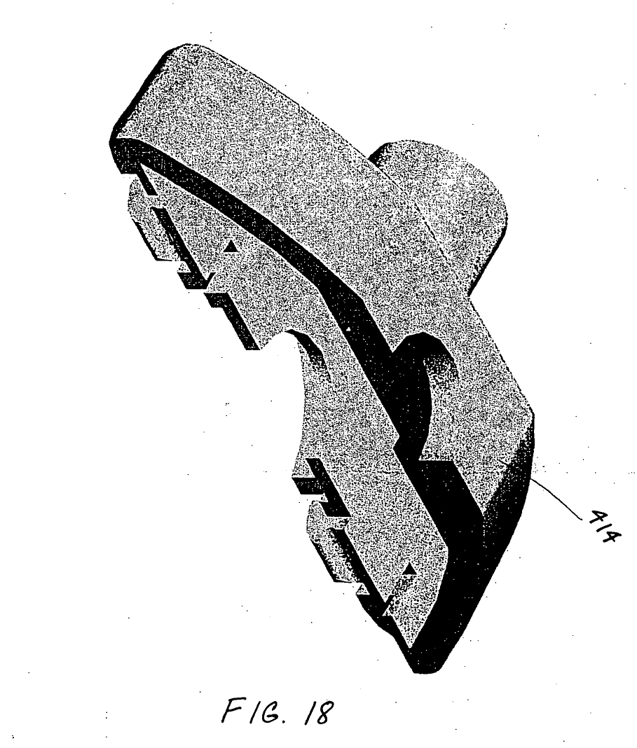

FIGS. 16 through 19 show an alternate device 410. Device 410 include housing 414 rotatably connected to a rod 426. FIG. 17 shows an opposite side of housing 414 revealing a rotatable member 412 disposed therein. Member 412 can be rotated in a direction shown by arrow B by rotating rod 426 as shown by arrow A. Means 422 can connect housing 414 to cord 16 in a position such that when member 412 is rotated, cord 16 is effectively shortened. FIG. 18 is a view of housing 414, not including member 412. FIG. 19 is a perspective view of member 412, including some of the gearing used to translate the rotation of rod A 90°.

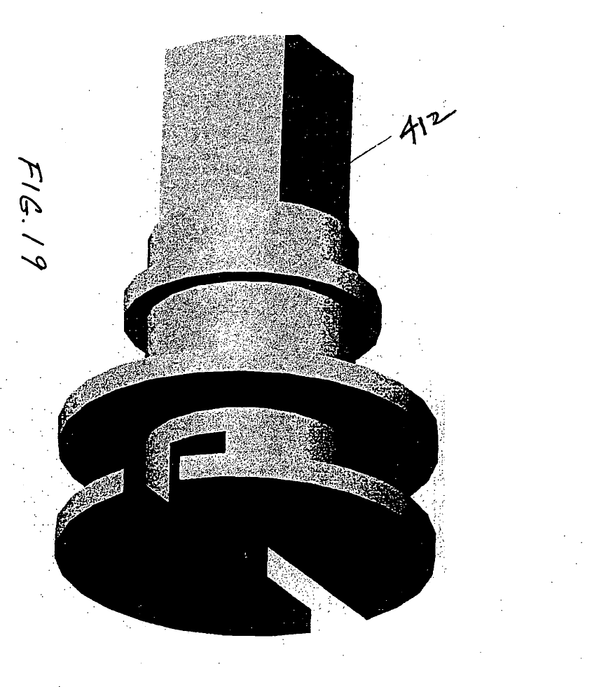

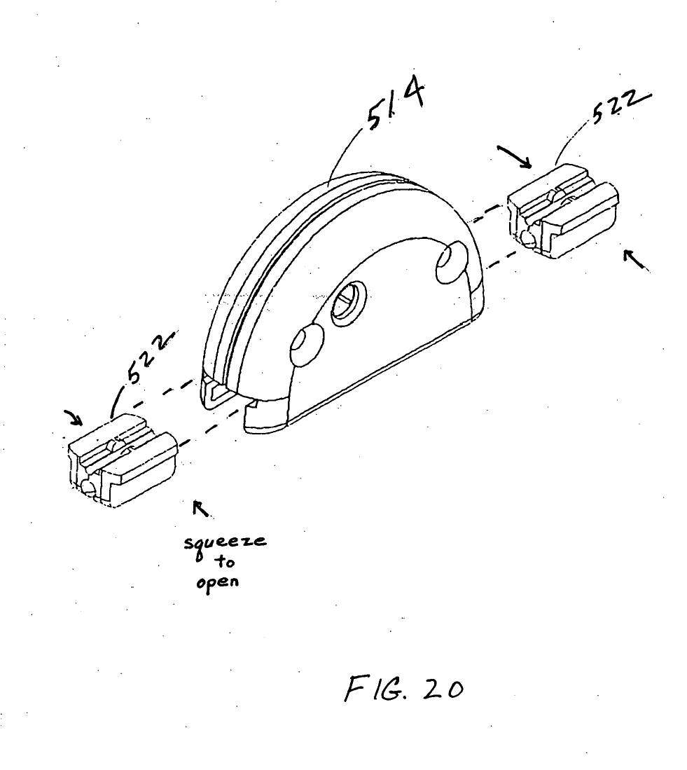

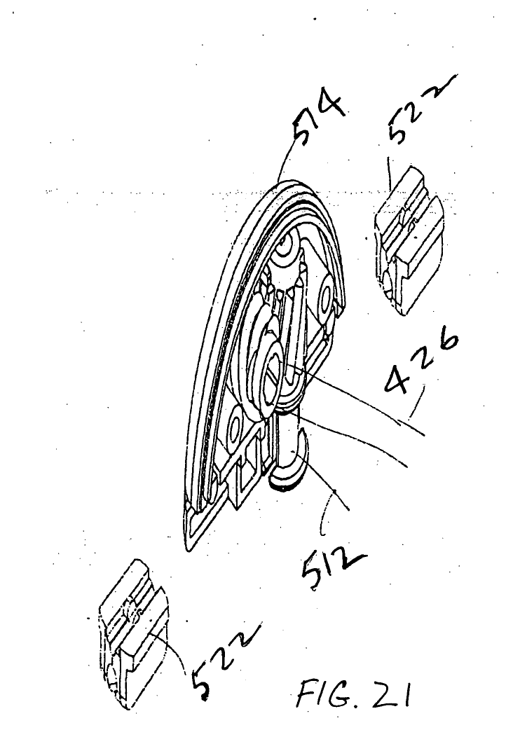

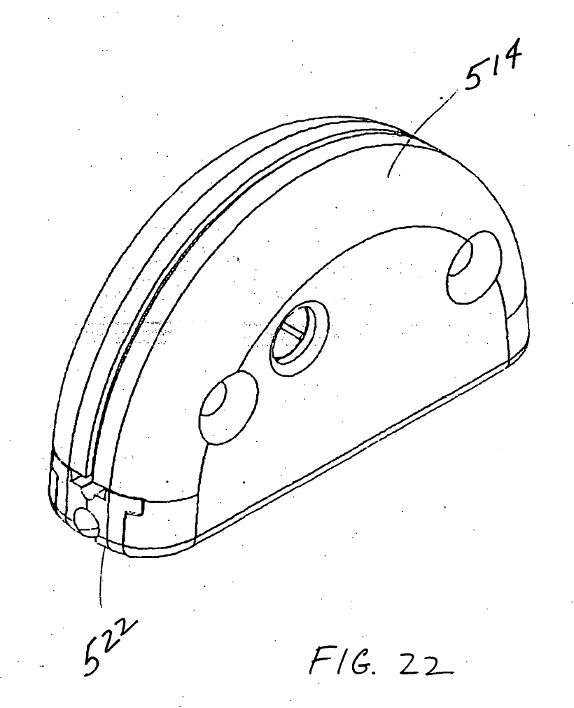

FIGS. 20 through 22 pertain to an alternate embodiment 514 of housing 414. Including removable cord attachment means 522 which can be opened for attachment by squeezing opposite a slot, and are then bias to clamp down on cord 16. FIG. 21 shows an inside view of housing 514 including a gear mechanism to translate the rotatation of rod 426 90° to a shaft 512. FIG. 22 is a view of housing 514 where means 522 are coupled thereto.

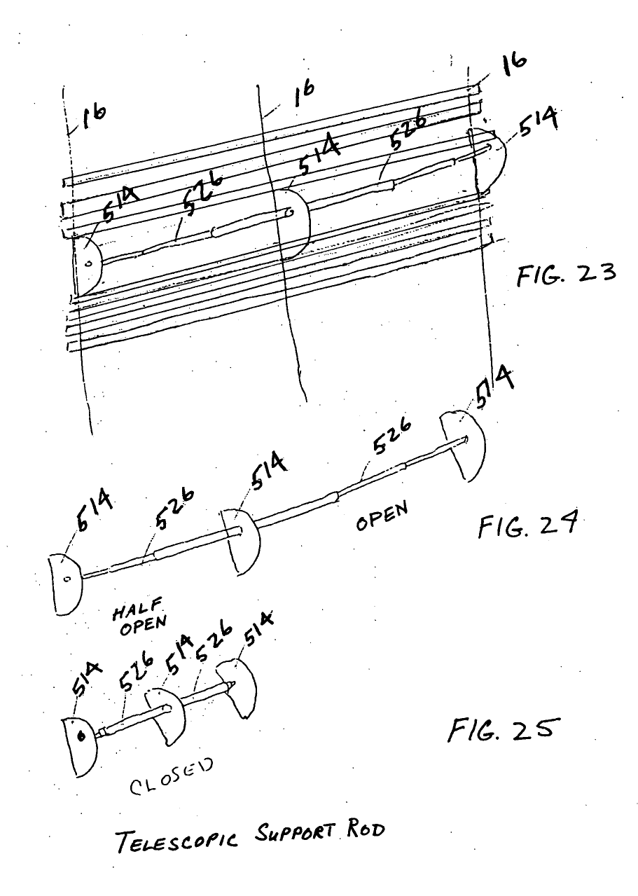

FIGS. 23 through 25 show an alternate rod 526 which rather than having a fixed length is telescoping.

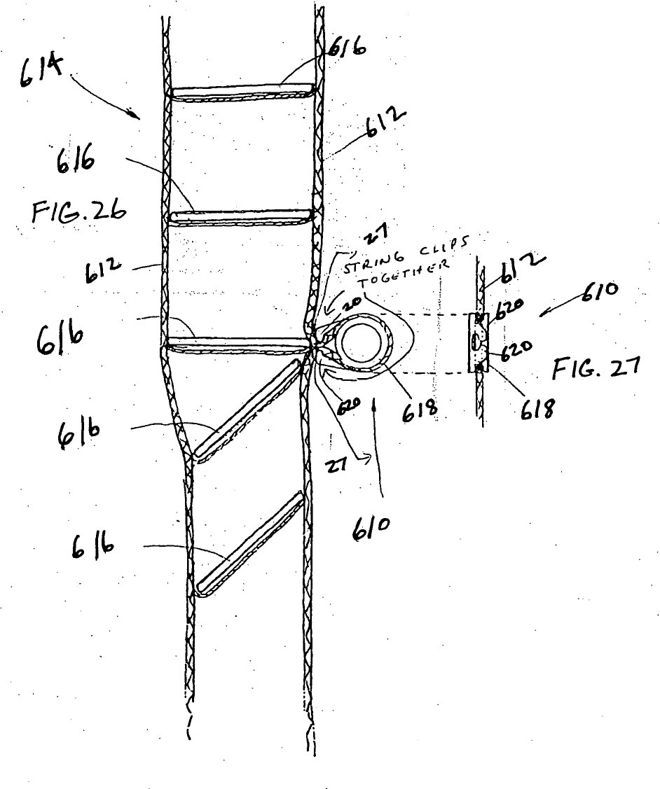

FIG. 26 is a view of the adjustment device 610 and disposed on a ladder cord 612 of a venetian blind 614 shown in cross-section. Venetian blind 614 includes a plurality of slat 616 which can be seen in the Figure, slats above adjustment device 610 are generally disposed horizontally in an open position, whereas those slats located below device 610 are disposed in an angled, or closed or partially closed position. This occurs by effectively shortening one of the ladder cords 612 between two adjacent slats 616.

Adjustment device 610 includes a spool 618 around which a portion of the ladder cord 612 is the disposed. Extending from spool 618 are clips 620 which releasably grab ladder cord 612. Device 610 could be formed, for example, resilient polymer.

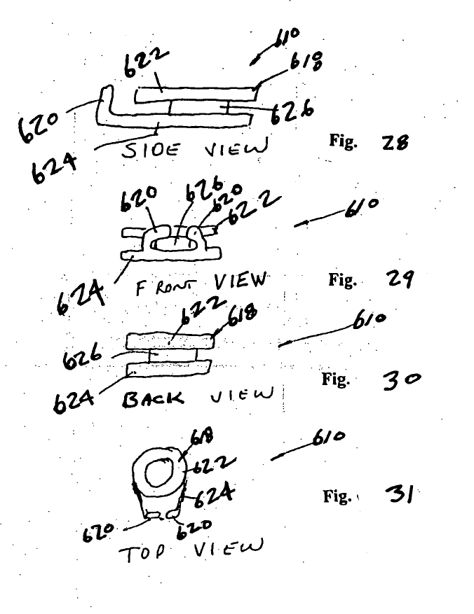

FIG. 27 is a front view of adjustment device 610. FIG. 28 is a side view of adjustment device 610 further showing spool 618 including a generally circular end 622 and an end 624 connected to clips 620. Generally a slenderical portion 626, spool 618, is disposed between ends 622 and 624. FIG. 29 is another view of device 610. FIG. 30 is back view of device 610, and FIG. 31 is a top view of device 610.

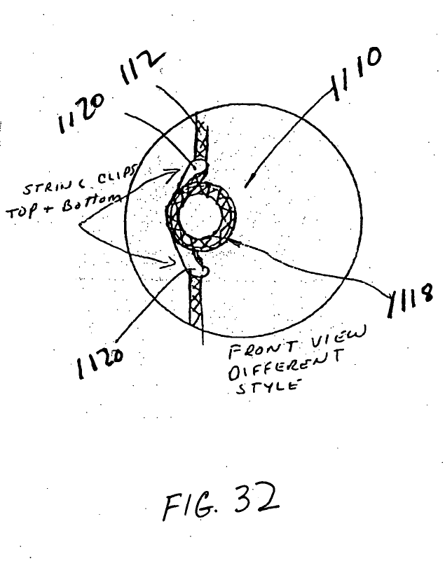

FIG. 32 shows an alternate embodiment of an adjustment device 1110. Adjustment device 1110 includes a spool 1118 and oppositely disposed clips 1120. Ladder cord 612 can be wrapped around spool 1118 to effectively shorten it. Device 1110 is used in a similar way as device 610.

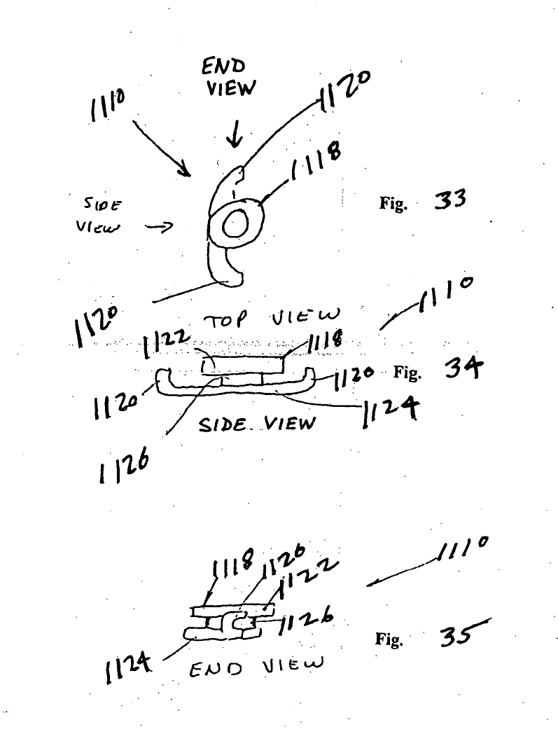

FIG. 33 is a top view of device 1110. FIG. 34 is a side view of device 1110 showing spool 618 including ends 1122 and 1124. End 1124 is connected to clips 1120. Generally slenderical portion 1126 of spool 1118 is disposed between ends 1122 and 1124. FIG. 35 is an end view of device 1110.

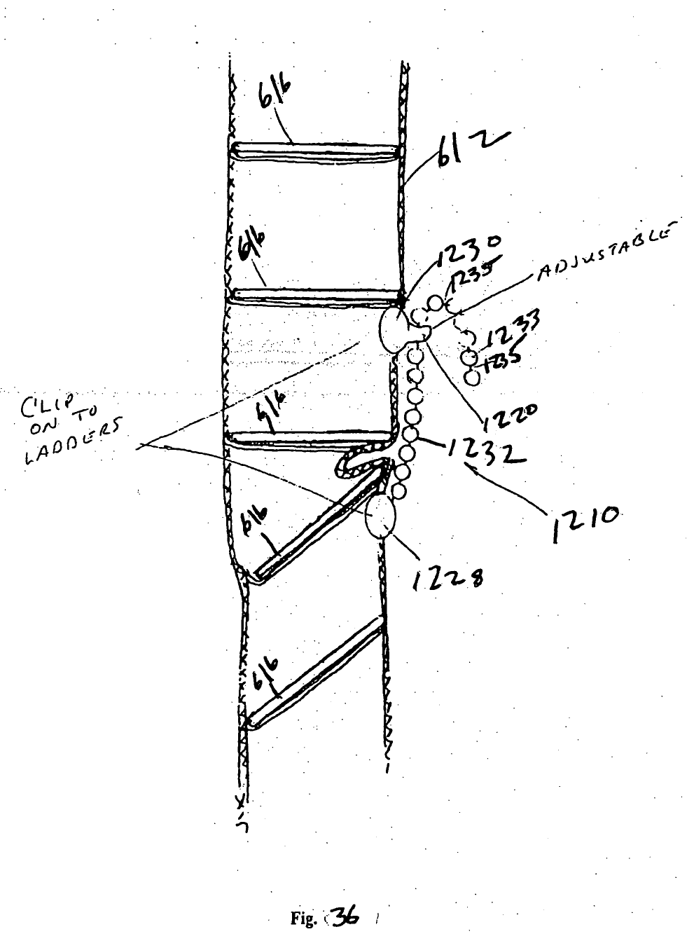

FIG. 36 shows an alternate adjustment device 1210 disposed on ladder cord 612. Device 1210 includes two ladder cord attachment devices 1228 and 1223, such as clips. Attachment device 1230 includes an additional clip 1220 for releasably and adjustably holding chain 1232. Chain 1232 can include a plurality of, for example, generally spherical members 1233 which are separated by narrow members 1235. Clip 1220 can selectively engage chain 1232 between members 1233 to effectively shorten or lengthen ladder cord 612.

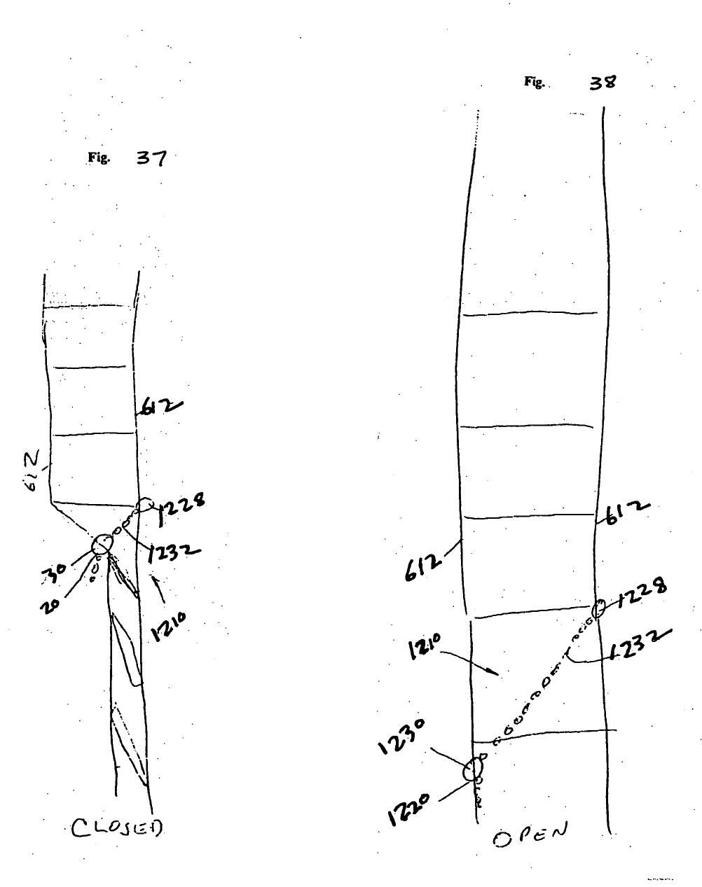

FIG. 37 is a cross-sectional view of a venetian blind similar to that shown in FIG. 36 where attachment devices 1228 and 1230 have been attached on opposite ladder cords 612. In FIG. 37, the blind is shown in partially selectively closed position whereas in FIG. 38, the blind is shown in a selectively opened position.

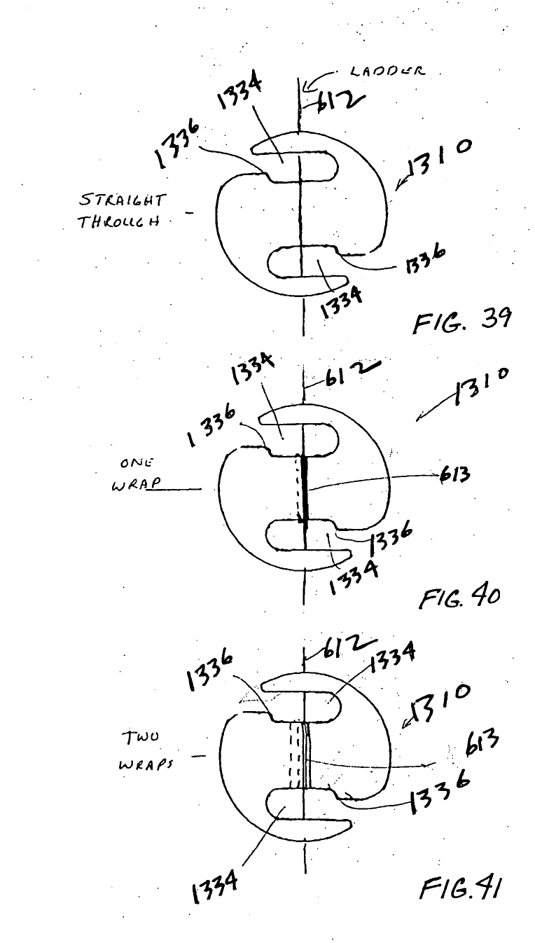

FIG. 39 shows an alternate adjustment device 1310 disposed on a ladder cord 612. Device 1310 includes oppositely disposed openings 1334 having a narrowed region 1336. Ladder cord 1312 is shown extending through openings 1334.

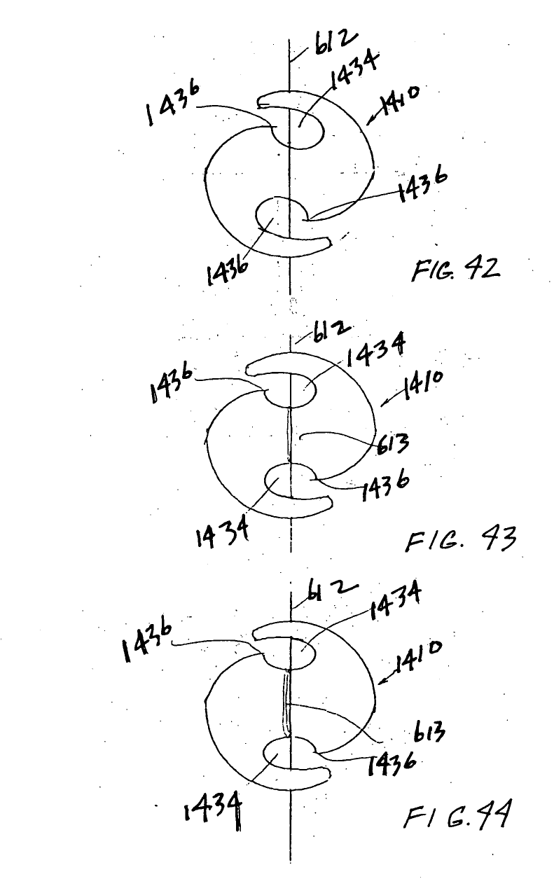

In FIG. 40 ladder cord 612 has been wrapped at location 613 once to shorten ladder cord 612. In FIG. 41, ladder cord 612 has been wrapped yet again at location 613 to further effectively shorten ladder cord 612.

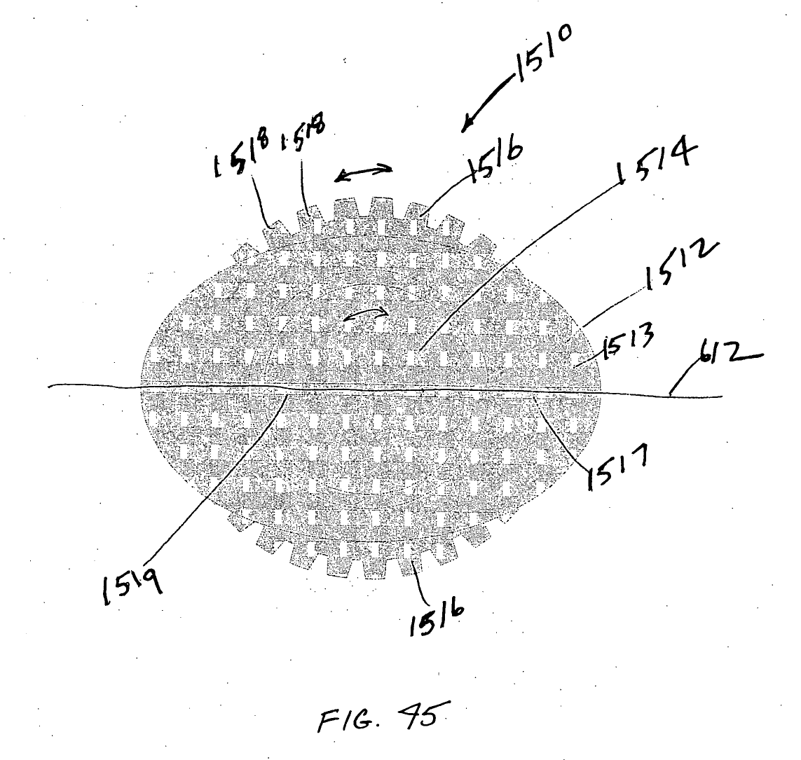

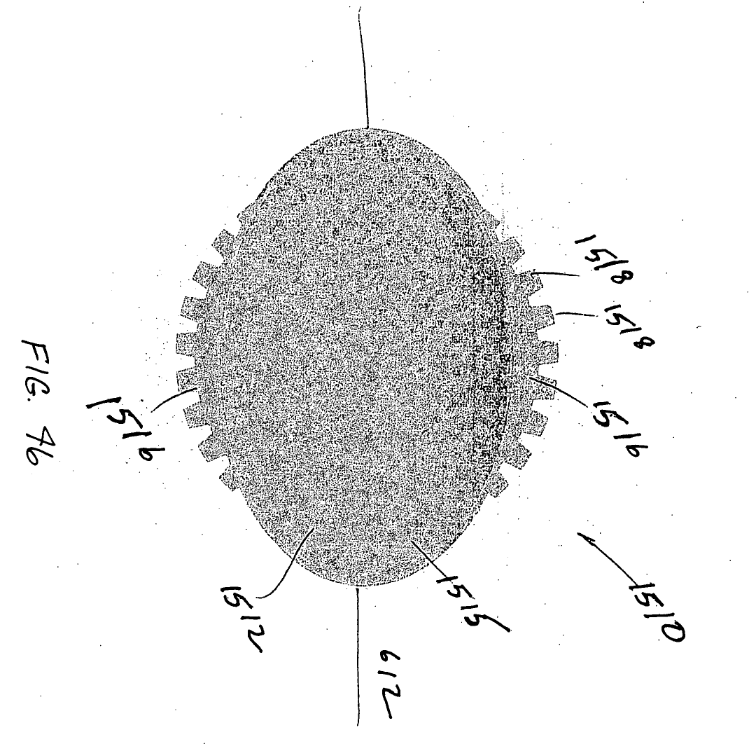

FIG. 42 shows an alternate adjustment device 1410 very similar to adjustment device 1310. Device 1410 includes openings 1430 having narrow portions 1436. In FIG. 43, ladder cord 612 is effectively shortened by wrapping it once around location 613. FIG. 44 shows ladder cord 612 further effectively shortened by wrapping it once again at location 613.

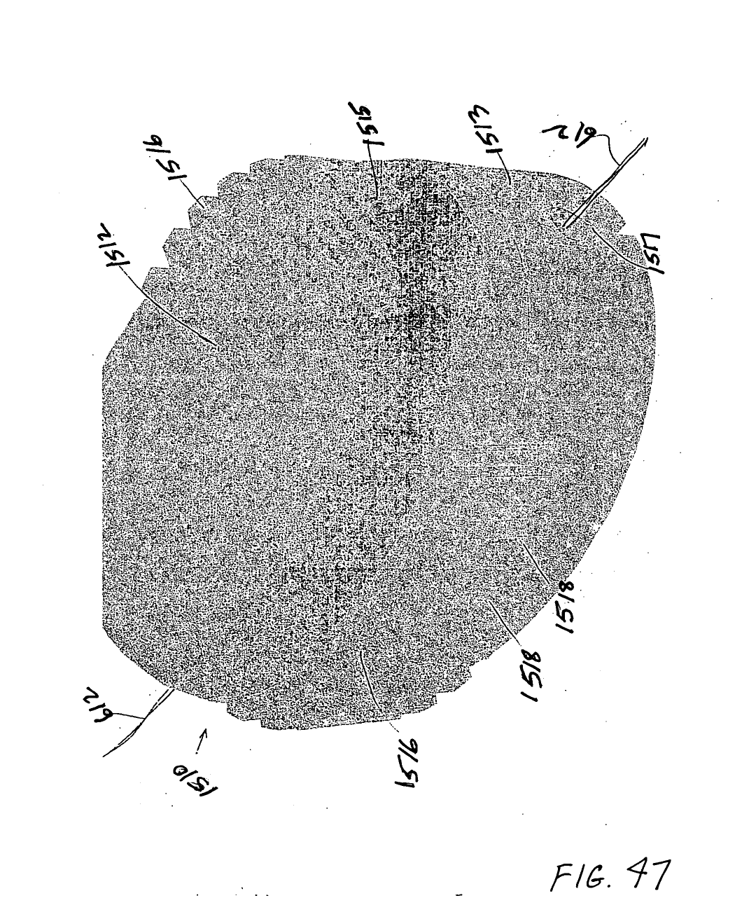

FIG. 45 is a bottom view of an alternate adjustment device 1510 for effectively shortening a ladder cord 612. Device 1510 includes a housing 1512 having a base 1513. A spool 1514 is rotatably disposed within housing 1512 and operably connected to a rotatable figure wheel 1510 having serrations 1518. Slots 1517 and 1519 extend through housing 1512 and spool 1514 respectively.

As shown in FIG. 45, slots 1517 and 1519 are aligned and a ladder cord 612 extends straight through each slot. If wheel 1516 is rotated by an operator to rotate spool 1514, ladder cord 612 can be wrapped around spool 1514 to effectively shorten ladder cord 612. Spool 614 can be held in place by friction fit with housing 1512 or a locking member (not shown).

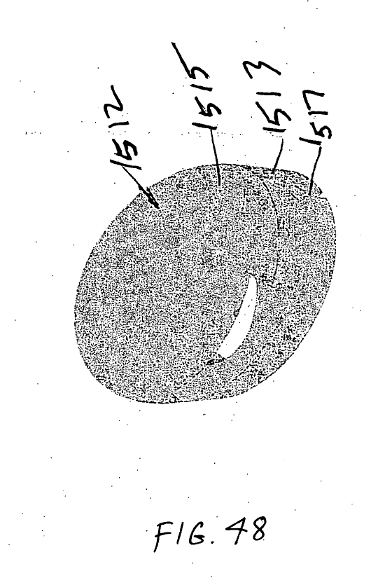

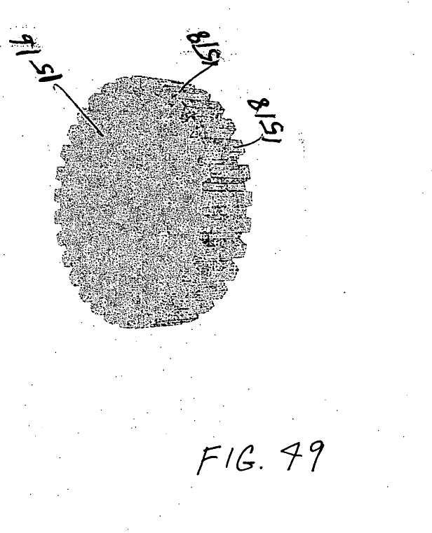

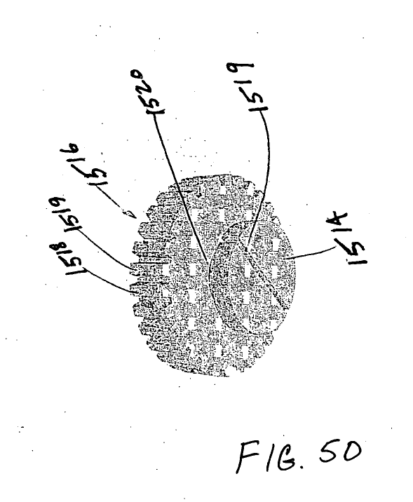

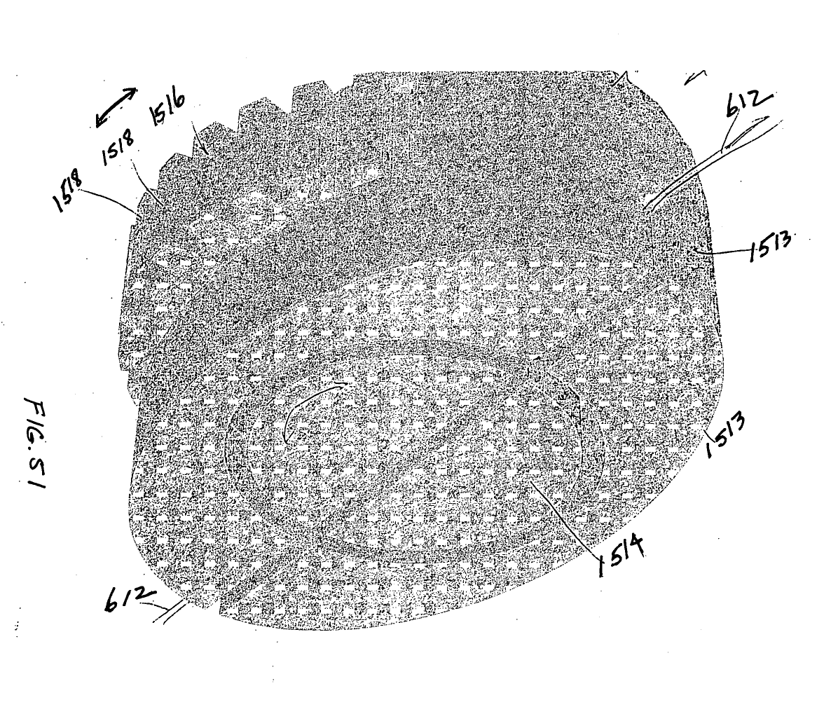

FIG. 46 is a top view of device 1510 showing housing 1512 including a top portion 1515. FIG. 47 is a top perspective view of device 1510. FIG. 48 is a top perspective view of housing 1512. FIG. 49 is a top perspective view of finger wheel 1516. FIG. 50 is a bottom perspective of wheel 1518 showing spool 1514 connected thereto by generally slenderical member 1520. FIG. 51 is a bottom perspective view of device 1510.

1. A device for selectively closing a venetian blind, comprising:
a spool bounded by two oppositely disposed ends; and
a clip connected to the spool.
